(19) United States
(12) Patent Application Publication
(10) Pub. No.: US 2010/0063878 A1
(43) Pub. Date: Mar. 11, 2010

(54) RETRIEVING METADATA

(75) Inventors: Franck Bachet, Breval (FR); David Poupon, Conflans Sainte Honorine (FR); Andrea Surcouf, Saint Leu La Foret (FR)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Staines, Middlesex (GB)

(21) Appl. No.: 12/450,909

(22) PCT Filed: Apr. 29, 2008
(86) PCT No.: PCT/IB2008/051659

§ 371 Date: Nov. 16, 2009

Related U.S. Application Data
(60) Provisional application No. 60/927,247, filed on May 2, 2007.

(51) Int. Cl. G06F 17/30; G06Q 30/00

(52) U.S. Cl. 705/14.49; 707/709; 707/769; 707/E17.108

(57) ABSTRACT

A method for retrieving metadata for use in a content guide is disclosed. The method includes: crawling one or more crawlable data sources; storing metadata extracted from the one or more crawlable data sources in an indexed cache; receiving a search request from a client according to search criteria, the search request requesting metadata for use in the content guide; searching a subset of the indexed cache according to the search criteria; extracting metadata from the indexed cache as results of the searching; identifying relevant metadata in the results, the relevant metadata including metadata suitable for use by the client in the content guide; and transmitting the relevant metadata to the client for use in the content guide.

### FIELD OF THE INVENTION

The present invention relates to methods and apparatus for retrieving metadata for use in a content guide.

### BACKGROUND OF THE INVENTION

An increasing number of set-top boxes (STBs) are hybrid boxes that have both a broadcast capability (e.g. cable and/or satellite and/or terrestrial television (TV)) and an IP capability (e.g. IPTV).

In a digital TV environment, the TV platform operator typically manages a bouquet of services, and is generally responsible for operating an infrastructure capable of delivering audio/visual (AV) content to the subscribers, often protected by a Conditional Access (CA) solution. The TV platform operator typically: receives content from one or more content providers who manage one or more TV channels in the TV bouquet; ensures the programs' and/or the channels' security (if Conditional Access protection is used); and inserts the content into the broadcast system (satellite, terrestrial, cable, IPTV, etc.) for reception by the subscribers.

An Electronic Program Guide (EPG) application available via an end user digital TV device (e.g. a STB or integrated receiver decoder (IRD)) is an on-screen guide to scheduled broadcast television programs, that allows a viewer to navigate, select and discover content by time, title, channel, genre, etc. using a remote control, a keyboard, a touch screen/pad, an inertia driven device (e.g. a Wii Remote) or even a telephone keypad.

Such an EPG comprises a graphical user interface, which enables browsing the list of channels made available in the digital TV bouquet. For example, the information is typically displayed in a grid with an option to select to receive more information on each program available in the selected time slot. The grid is typically extends over a number of pages (with a predetermined number of channels per page) and is typically arranged by slot times (with a predetermined number of slot times per page, e.g. from now 1 PM until tonight 8 PM). A subscriber can browse the EPG pages (up/down) and by selecting one particular entry in the EPG grid, the subscriber can select to display descriptive information about the selected item, such as a programme synopsis, actors, directors, year of production etc. (in another dedicated part of the user interface or in a new window). The list of channels may also comprise the programs on offer from sub-channels, such as pay-per-view (PPV) and video-on-demand (VOD) services. Depending on the metadata broadcast with the programmes, some EPGs allow subscribers to navigate channel listings up to 14 days into the future. EPG metadata is typically sent within the broadcast transport stream (e.g. as Service Information (SI) as specified in the Digital Video Broadcasting

Service Information (DVB-SI) standard (“Digital Video Broadcasting (DVB); Specification for Service Information (SI) in DVB systems”, ETSI EN 300 468)) or alongside the broadcast stream in a dedicated data channel (e.g. Really Simple Syndication (RSS) channels (RSS 2.0 Specification, www.rssboard.org)).

International Patent Application WO 2006/004170 of NDS Limited provides a solution for introducing additional content information related to events broadcast by a TV operator: it can be provided to subscribers without having an impact on the regular metadata broadcast by the TV operator and therefore without affecting the TV operator's broadcasting infrastructure. The EPG provided by a TV operator, the metadata used to construct the EPG and the method of transmitting the EPG to subscribers all remain the same. A search engine, under the control of the platform operator is used to feed the STB with additional metadata.

International Patent Application WO 02/41542 of Nokia Corporation describes a digital television system that includes service provider equipment for transmitting a digital television broadcast; and a set-top box for decoding the digital television broadcast and displaying the decoded broadcast on an analogue television. A processor arranged in the set-top box includes an agent or program for: receiving information transmitted with the digital television broadcast; searching the Internet for links based on the information; and displaying the list of links in response to a user input.

U.S. Pat. No. 6,005,565 to Legall et al. describes a search tool that enables a user to search an electronic program guide (EPG) and the Internet with one search. The search tool performs the search and modifies the display of the

EPG to identify programs identified by the search. A user can then view the EPG and select broadcasts of programs to display as well as proceed to the websites indicated by selecting corresponding elements on the display.

US published Patent Application US 2003/0226147 of Richmond et al. describes performing an Internet search based on a keyword obtained from an EPG.

The term “search engine” refers to a software program that searches the internet to find documents containing one or more specified keywords, and returns a list of documents in which the keywords were found. Broad-based search engines such as Google (www.google.com) or Yahoo (www.yahoo.com) fetch very large numbers of documents using a Web crawler. Another program called an indexer then reads these documents and creates a search index based on words contained in each document. Each search engine uses a proprietary algorithm to create its indexes so that, ideally, only meaningful results are returned for each query.

Vertical search engines, on the other hand, send crawlers out to a highly refined database, and therefore the indexes of vertical search engines contain information about a specific topic. As a result, vertical search engines are more valuable to people interested in a particular area.

### SUMMARY OF THE INVENTION

The amount of metadata used to populate an EPG is growing rapidly in part because of the increasing number channels that are accessible with the hybrid STBs as described previously but also because EPGs are increasingly giving end users access not only to broadcast content but also to additional content such as VOD content, downloadable content (e.g. Pull-VOD content), user generated content (UGC) etc. Consequently, it is becoming more and more complex to collate and organize such a large amount of data and to ensure that the data is accurate, reliable and of good quality.

The metadata types related to any particular program are specified in specifications such as DVB-SI, DVB-IPI and PSIP. The ability to add additional metadata types requires additional bandwidth for carrying the additional metadata which increases the cost of the overall infrastructure. A dedicated data channel for additional metadata is a possibility but relies on a pre-determined data format (on the server side) which must be understood on STB side (e.g. HTML).

As mentioned previously, feeding an EPG with data sourced from the internet is known. However, getting relevant results is difficult since an internet search engine (e.g. Google (www.google.com)) returns search results using a ranking algorithm that is based on Internet traffic and Internet page link structure and does not, as a default, provide only those results that can be consumed on a television display device. Therefore, when searching for a movie, the first search result provided by such a search engine is typically the URL of the internet home page of that movie, which is likely not to be suitable for use by the device. The device displaying the EPG would then have to retrieve the webpage targeted by the URL and then browse that page in order to retrieve any links on the page that can be used on the device.

There is provided according to an embodiment of the present invention a method for retrieving metadata for use in a content guide, the method including: crawling one or more crawlable data sources; storing metadata extracted from the one or more crawlable data sources in an indexed cache; receiving a search request from a client according to search criteria, the search request requesting metadata for use in the content guide; searching a subset of the indexed cache according to the search criteria; extracting metadata from the indexed cache as results of the searching; identifying relevant metadata in the results, the relevant metadata including metadata suitable for use by the client in the content guide; and transmitting the relevant metadata to the client for use in the content guide.

In some embodiments, the one or more crawlable data sources comprise one or more web pages.

In some embodiments, the method further includes storing the one or more web pages in the indexed cache; and extracting one or more web pages from the indexed cache as results of the searching.

In further embodiments, the one or more crawlable data sources further includes one or more local data sources within a network to which the client has access.

In other embodiments, the method further includes identifying advertisements for display in the content guide in dependence on the relevant metadata; and transmitting the advertisements to the client with the relevant metadata.

In some embodiments, the identifying advertisements is further dependent on one or more of the search criteria, the client, a history of search requests received, and advertisements previously identified and transmitted to the client.

In further embodiments, the search criteria specifies the subset of the indexed cache.

In other embodiments, the search criteria is established from the relevant metadata.

In further embodiments, the method further includes receiving a further search request according to further search criteria, the further search request requesting content related to content selected using the content guide.

In some embodiments, the further search criteria is established from the relevant metadata.

In other embodiments, the further search criteria is specified by a user of the content guide.

There is also provided in accordance with a further embodiment of the present invention a method for retrieving metadata for use in a content guide installed on a client device, the method including: sending a search request according to search criteria to a search server, the search request requesting data for use in the content guide, wherein the search server is operable to crawl one or more crawlable data sources, store metadata extracted from the one or more crawlable data sources in an indexed cache, search a subset of the indexed cache according to the search criteria, extract metadata from the indexed cache as results of the searching, identify relevant metadata in the results, the relevant metadata including metadata suitable for use in the content guide, and transmit the relevant metadata to the client device; receiving the relevant metadata from the search server; and presenting the relevant metadata in a content guide.

In some embodiments, the one or more crawlable data sources include one or more web pages.

In other embodiments, the search server is operable to store the one or more web pages in the indexed cache; and extract one or more web pages from the indexed cache as results of the searching.

In other embodiments, the method further includes publishing content available within a network to which the client has access, wherein the search server is further operable to crawl the content and store the content in the indexed cache, wherein the content can be included in the search by the search server in response to the search request.

In some embodiments, the method further includes publishing the content directly to the search server.

In other embodiments, the method further includes publishing the content to a web page crawled by the search server.

In other embodiments, the method further includes: crawling content available within a network to which the client has access; storing the content in a local indexed cache; searching a subset of the local indexed cache according to the search criteria; extracting content from the local indexed cache as local results of the searching; identifying relevant local metadata in the local results; merging the relevant local metadata with the relevant metadata; and presenting the local relevant metadata and the relevant metadata in a content guide.

In some embodiments, the indexed cache includes the local indexed cache.

There is also provided in accordance with a further embodiment of the present invention apparatus for retrieving metadata for use in a content guide, the apparatus including: crawling means for crawling one or more crawlable data sources; indexed storage means for storing metadata extracted from the one or more crawlable data sources; searching means for receiving a search request from a client according to search criteria, the search request requesting metadata for use in the content guide, and for searching a subset of the indexed storage means according to the search criteria; and extraction means for extracting metadata from the indexed storage means as results of the searching, and for identifying relevant metadata in the results, the relevant metadata including metadata suitable for use by the client in the content guide; wherein the searching means is operable to transmit the relevant metadata to the client for use in the content guide.

There is also provided in accordance with a further embodiment of the present invention a search engine for retrieving metadata for use in a content guide, the search engine including: a global search engine operable to crawl one or more crawlable data sources; an indexed cache operable to store metadata extracted from the one or more crawlable data sources; a vertical search engine operable to receive a search request from a client according to search criteria, the search request requesting metadata for use in the content guide, and further operable to search a subset of the indexed cache according to the search criteria; and a snippet generator operable to extract metadata from the indexed cache as results of the searching, and further operable to identify relevant metadata in the results, the relevant metadata including metadata suitable for use by the client in the content guide; wherein the searching means is further operable to transmit the relevant metadata to the client for use in the content guide.

There is also provided in accordance with a further embodiment of the present invention a client device including: presentation means for presenting a content guide to a user; searching means for receiving a search request according to search criteria from the presentation means, and sending the search request to a search server, the search request requesting data for use in the content guide, wherein the search server is operable to crawl one or more crawlable data sources, store metadata extracted from the one or more crawlable data sources in an indexed cache, search a subset of the indexed cache according to the search criteria, extract metadata from the indexed cache as results of the searching, identify relevant metadata in the results, the relevant metadata including metadata suitable for use in the content guide, and transmit the relevant metadata to the client device; and receiving means for receiving the relevant metadata from the search server, and wherein the presentation means is operable to present the relevant metadata in the content guide.

There is also provided in accordance with a further embodiment of the present invention a client device including: a guide presenter operable to present a content guide to a user; and a guide engine operable to receive a search request according to search criteria from the guide presenter, and send the search request to a search server, the search request requesting data for use in the content guide, wherein the search server is operable to crawl one or more crawlable data sources, store metadata extracted from the one or more crawlable data sources in an indexed cache, search a subset of the indexed cache according to the search criteria, extract metadata from the indexed cache as results of the searching, identify relevant metadata in the results, the relevant metadata including metadata suitable for use in the content guide, and transmit the relevant metadata to the client device; wherein the guide engine is further operable to receive the relevant metadata from the search server, and send the relevant metadata to the guide presenter, and wherein the guide presenter is further operable to present the relevant metadata in the content guide.

### BRIEF DESCRIPTION OF THE DRAWINGS

The present invention will be understood and appreciated more fully from the following detailed description, taken in conjunction with the drawings in which:

FIG. 1 is a partly pictorial, partly block diagram illustration of a Universal Programme Guide (UPG) system constructed and operative in accordance with embodiments of the present invention;

FIG. 2A is a block diagram illustration of a Universal Program Guide system architecture constructed and operative in accordance with embodiments of the present invention;

FIG. 2B is a block diagram illustration of a Universal Program Guide system architecture constructed and operative in accordance with further embodiments of the present invention;

FIG. 2C is a block diagram illustration of a Universal Program Guide system architecture constructed and operative in accordance with further embodiments of the present invention;

FIG. 2D is a block diagram illustration of a Universal Program Guide system architecture constructed and operative in accordance with further embodiments of the present invention;

FIG. 2E is a block diagram illustration of a Universal Program Guide system architecture constructed and operative in accordance with further embodiments of the present invention;

FIG. 2F is a block diagram illustration of a Universal Program Guide system architecture constructed and operative in accordance with further embodiments of the present invention;

FIGS. 3A and 3B show a series of examples of UPG screenshots in accordance with embodiments of the present invention;

FIG. 4 is an information flow diagram for a UPG constructed and operative in accordance with embodiments of the present invention;

FIGS. 5A and 5B comprise information flow diagrams showing the information flows during a search request to a UPG constructed and operative in accordance with embodiments of the present invention;

FIG. 6 is block diagram of device architecture constructed and operative in accordance with embodiments of the present invention;

FIG. 7 is a block diagram of a device embedding UPG modules constructed and operative in accordance with embodiments of the present invention;

FIG. 8 is an illustration of a query tree built by a vertical search engine according to embodiments of the present invention;

FIG. 9 is an abstract representation of content managed in a UPG system constructive and operated in accordance with embodiments of the present invention; and

FIG. 10 is a block diagram illustration of a vertical search engine architecture constructed and operative in accordance with embodiments of the present invention.

### DETAILED DESCRIPTION OF EMBODIMENTS

Embodiments of the present invention will now be described in the context of a content guide or Universal Program Guide (UPG). A UPG has some or all of the following properties:
Multimedia content displayed within the UPG may come from multiple sources, such as, by way of non-limiting example: satellite TV, digital terrestrial TV (DTT), cable TV, IPTV, video on demand (VOD), user generated content (UGC) from the internet etc.
Multiple types of content may be displayed, such as, by way of non-limiting example: broadcast channel audio/video content, on demand audio/video content, user generated contents (e.g. audio/video, images, animations) etc.
The UPG gives easy access to associated content, i.e. similar content, and/or the UPG can suggest relevant alternative content when possible (DVD, T-shirts, etc.);
A user is able to define his own “virtual channels” which combine, such as, by way of non-limiting example: broadcast content and/or on demand content from TV bouquets and/or internet content;
All/several content sources are merged together in one global source within the UPG; and
The description of content may come from multiple and independent sources.

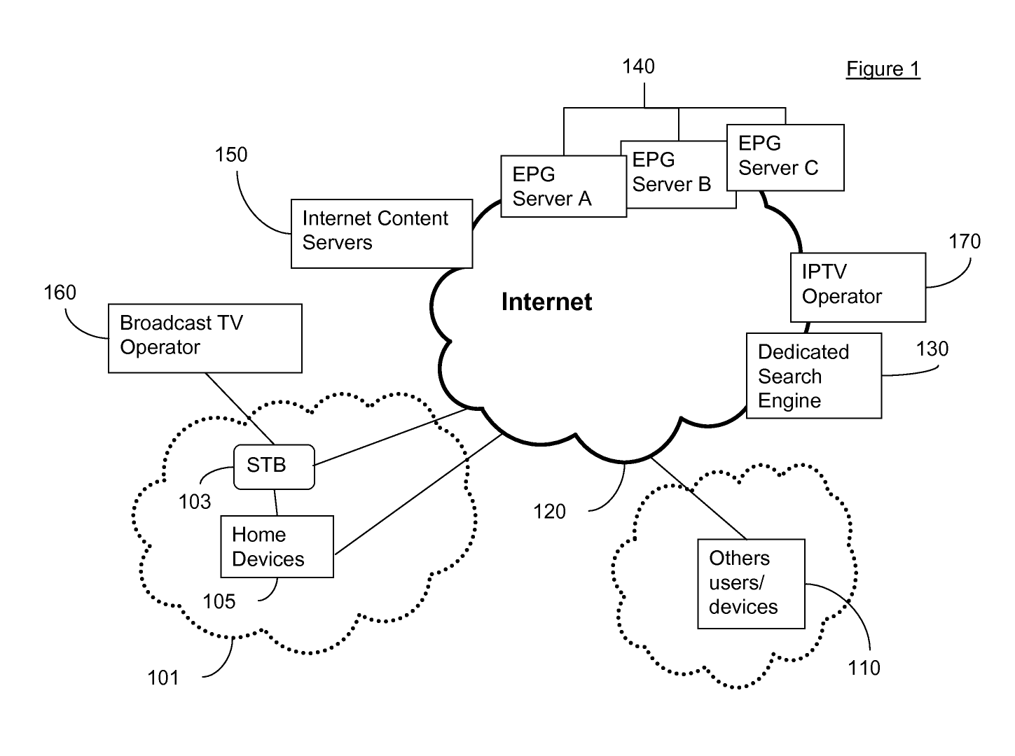

Reference is now made to FIG. 1, which depicts a home network 101, comprising a STB 103. STB 103 is interfaced with:
Others devices 105 in the home network 101 (e.g. a PC);
Other users/devices 110 via the Internet 120 (e.g. another STB, a PC, a mobile phone etc.);
A dedicated UPG Search Engine 130 via internet 120;
EPG Web Content providers (EPG server A; EPG server B; and EPG server C) 140 via internet 120;
Internet content Servers (community server) 150 via internet 120 (e.g. servers operated by internet websites providing, for example, user generated content, such as MySpace.com, YouTube.com etc.);
One (or more) broadcast TV operators 160 (e.g. cable, satellite, terrestrial) and
One (ore more) IPTV operators 170 via internet 120.

STB 103 is operable to receive broadcast TV programs from either broadcast TV operator 160 or from IPTV operator 170. STB 103 offers users the ability to navigate through a list content via a UPG.

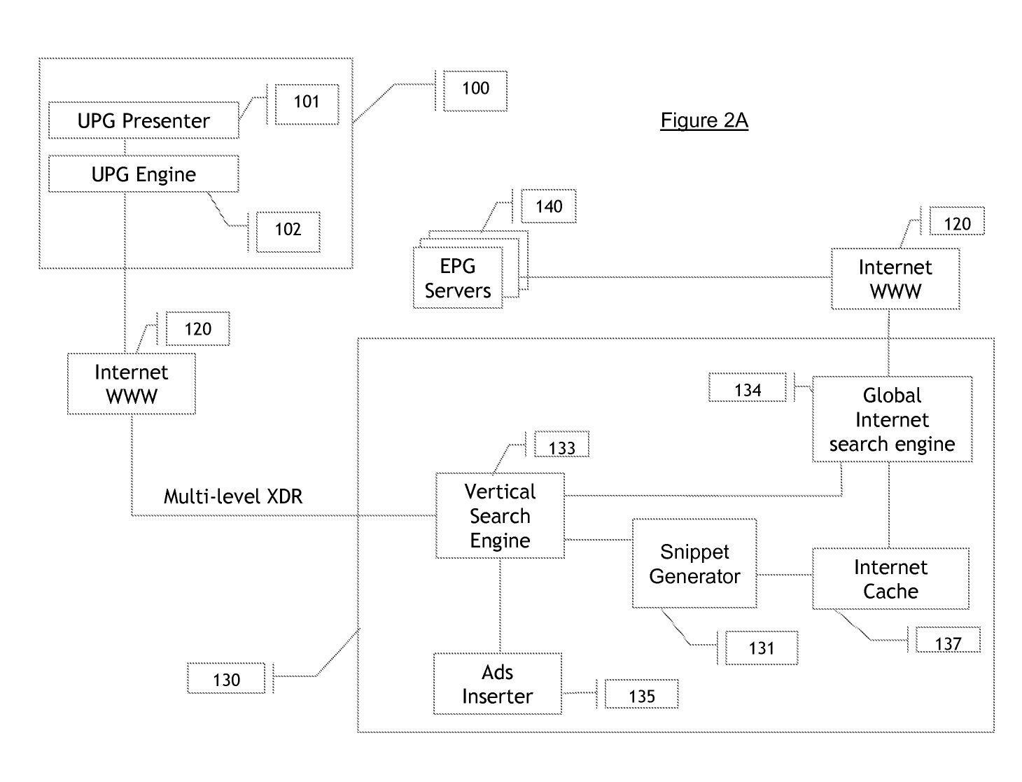

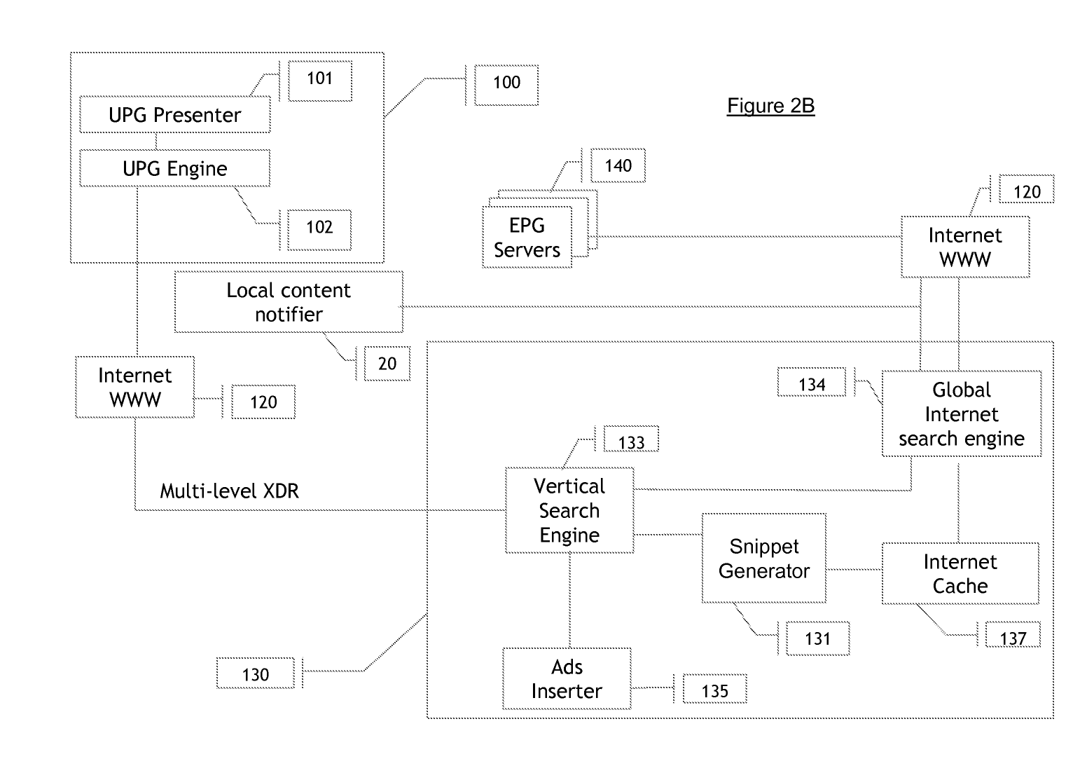

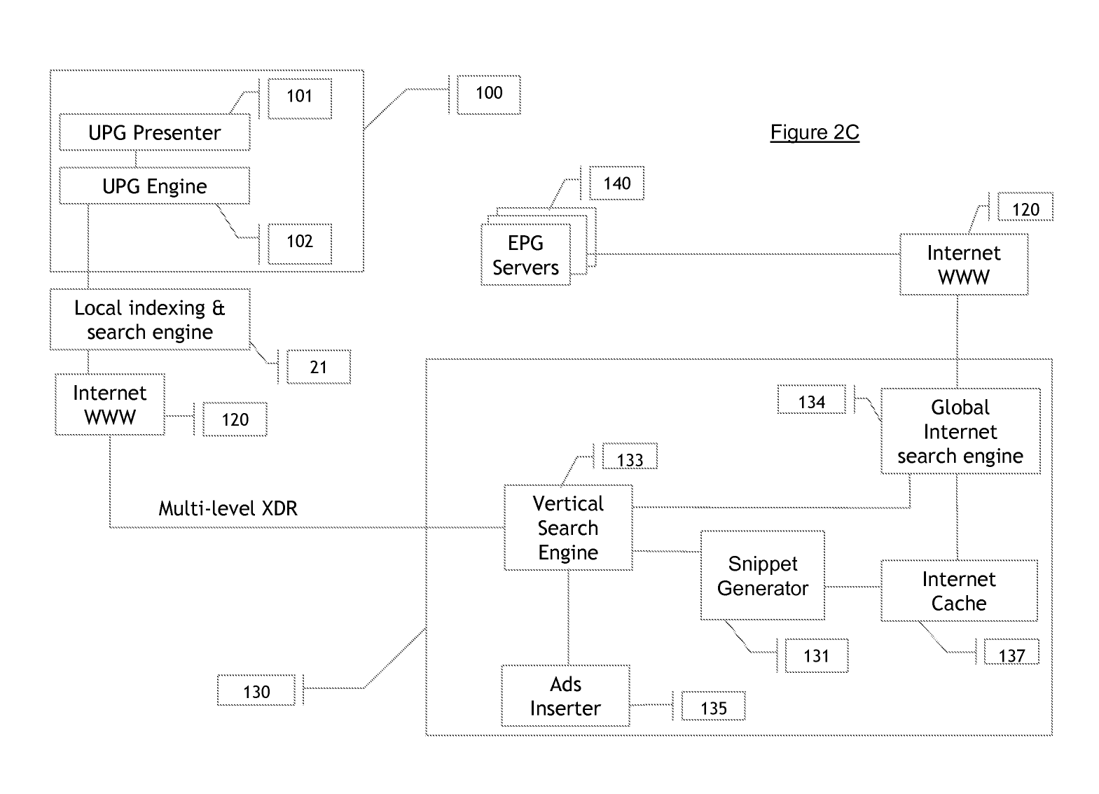

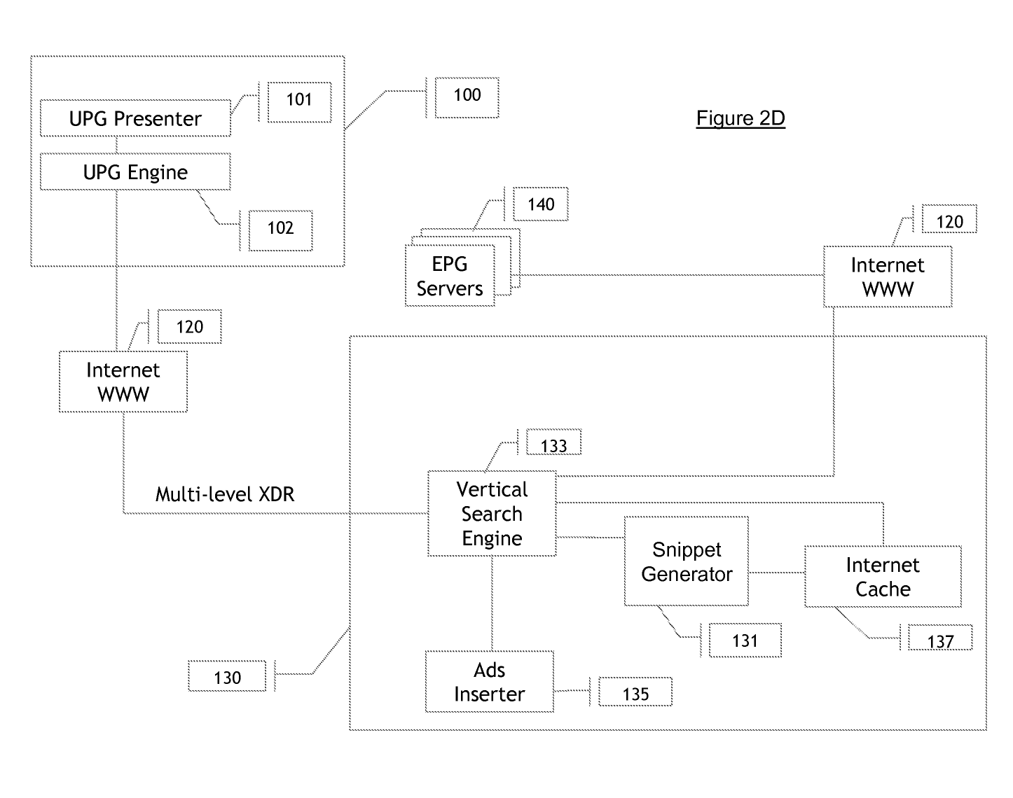

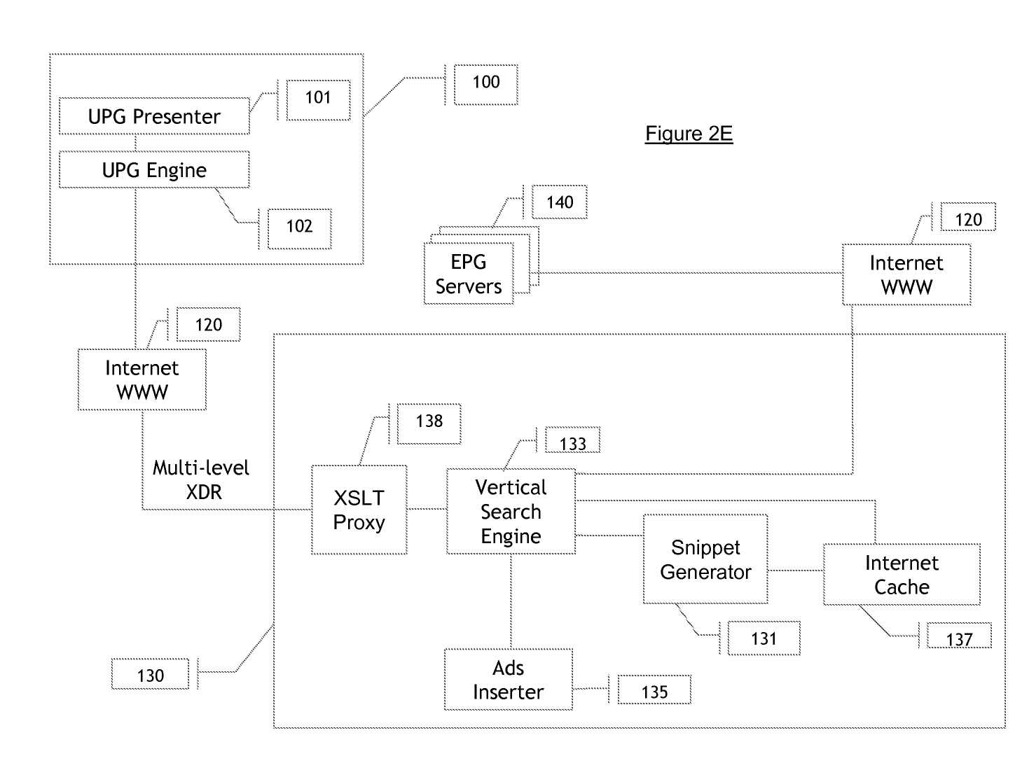

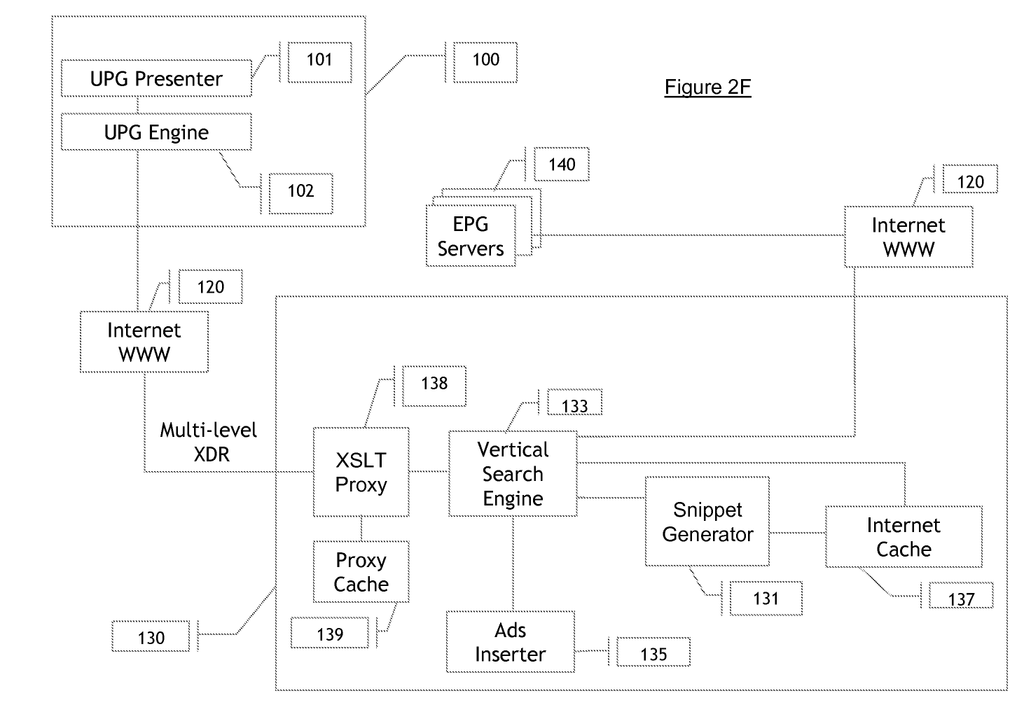

Reference is now made to FIG. 2A. The UPG client 100 (which is a component of STB 103 in the present embodiment) is made of two components: UPG Presenter 101 (used for application display and user interaction with UPG client 100) and the UPG engine 102 (used by UPG client 100 to communicate with other parts of the UPG system). When a user selects a menu or an action via an application displayed on TV screen (associated with STB 103) by the UPG Presenter 101, a request is sent via the UPG engine 102 to the dedicated UPG Search Engine 130. In the present embodiment, a request/response process takes place over Internet 120 (e.g. using TCP/IP).

The UPG Search Engine 130 is made of several components:
A global search engine 134 (e.g. google.com) which crawls the web via the Internet 120 in order to index web pages/content. For example, EPG servers 140, under the control of a TV operator (or any independent third party) publish metadata on the Internet that describes content available within a TV bouquet. Once published on the Internet by the EPG servers, this metadata is available to global search engine 134. Also, metadata is published on the Internet by web content servers 150 that is also available to global search engine 134 (although not shown).
An Internet cache 137 (e.g. Google Cache) which keeps a copy of each web page crawled and indexed by the global search engine 134. This copy of the original web page may be provided later to any component of the system (or external component) without having to contact the original server that hosts the web page. In alternative embodiments, the global search engine 134 only extracts and indexes metadata from the crawled webpages and stores the metadata in interne cache 137.
A Vertical Search Engine 133 (e.g. Google Co-op (www.google.com/coop/)), which is customized, for example, for use in the context of digital TV. The VSE 133 interfaces with STB 103, and receives the search request. VSE 133 is able to perform “custom searches” within the index of the global search engine 134. “Custom searches” means (but is not limited to) the ability to restrict the scope of the search of the global index to a predefined list of web sites (or even parts of a web site), the ability to influence the ranking algorithm used to choose the results, the ability to reorder the results, and the ability to impose some rules for snippet generation (which will be described in more detail below). This custom search mechanism guarantees the relevance of the search results to the digital TV context. VSE 133 customization includes a list of Internet content servers 150 and EPG servers 140 to be taken into account in the search. Vertical Search Engine 133 is also stores incoming search requests representing the “inside UPG” navigation made by the user. By using such a search history database, Vertical Search Engine 133 is capable of adapting the relevance and ranking of the “custom search” results to better match end user expectations. The Vertical Search Engine typically:
defines of a list of content provider web sites list to be used as the index sources for performing the searches. Some content providers may be the TV operators themselves who publish metadata on available broadcast or other on demand content. It is to be noted that the publication of such metadata may also be performed by independent third parties.
defines a ranking to be applied to the index sources in order to manage a list of relevant search results to be returned to end user devices. For example, content managed by one of the TV Operators has the highest ranking level while content provided for free by a third party has an inferior ranking level so that in the list of search results, the TV Operator content is returned as having the higher ranking.
sends back the results to the device using a metadata format suitable for the user device.

On the end user device side, the UPG engine 102 supports the ranking level as a way to browse results with various depth layers. In this way, the display of content information is managed on screen for the end user. The UPG can then be used to browse several sources of content (e.g. TV broadcast content, Pay Per View services, VOD service managed by the digital TV operator, VOD service managed by a third party, content available on Internet including user generated content etc.) with ranking levels that are defined by the entity in charge of the UPG Search Engine.
A snippet generator 131: A snippet is a summary generated on a per document basis for each web page that is crawled and indexed by global search engine 134. For example, when an ordinary search is carried out using an internet search engine such as Google, the search engine returns a list of search results and each search result is accompanied by a snippet comprising a small amount of textual description extracted from the cached search result along with a link for accessing the source document on the web site that was originally crawled by the search engine. For each result of the custom search, snippet generator 131 extracts relevant information from the document stored within Internet cache 137 (based on rules imposed by vertical search engine 133) and creates a snippet which, in the present embodiment, is compliant with the eXternal Data Representation (XDR) format (a 1995 standard of the Internet Engineering Task Force (IETF) that allows data to be wrapped in an architecture independent manner so that the data can be transferred between heterogeneous computer systems). The rules provided by VSE 133 to snippet generator 131 include (but are not limited to) instructions on the way to find relevant information depending on the original web site, the web page structure, the type of the web page, and the XDR format suitable for UPG engine 102. The snippet metadata is used to populate the UPG with relevant information to help the user of the UPG select content to consume.
(Optional) Ads Inserter 135, which selects advertisements to display in the UPG depending on different input parameters like (but not limited to) the search criteria, the search results, the VSE parameters, search history database content, previous selected advertisements, target device type and so forth. These advertisements may have many different formats such as (but not limited to) text, html, xml, image, video, animations etc.

In the present embodiment, snippets comply with the XDR format because:
Original metadata indexed by VSE 133 may not always be suitable for consumption by UPG Engine 102;
Computation power is not an issue in a Web Services infrastructure while it may be an issue on the end user side since device computation power may be restricted;
It helps to avoid the overloading of traffic between STB 103 and UPG Search engine 130 with unwanted metadata;
a Server Centric approach for maintenance is more efficient for situations where an EPG metadata source is updated (enabling a server upgrade instead of a software download for each end user device);
it enables the snippet generator to be device and/or user profile specific;
a single container format is used for returning the responses from the indexed documents that match the query, the documents themselves potentially originating from multiple and/or independent sources.

Reference is now made to FIG. 2B, which depicts an alternative embodiment of the present invention that supports the search of local content available within home network 101. The local content identifier 20 can discover local content available within home network 101 and publishes metadata associated with that local content to Global search engine 134. VSE 133 customizes the search request in order to include this local content metadata in the scope of the search. This embodiment can be extended further to include metadata published by other users. The publication of local content metadata may be done directly through an interface provided by global search engine 134, or by publishing such metadata on a dedicated Internet web site crawled by global search engine 134.

Reference is now made to FIG. 2C, which depicts an alternative embodiment of the present invention that supports the search of local content available within home network 101. In this alternative embodiment, local content metadata is not published to global search engine 134. Rather, a local search engine 21 discovers, crawls and indexes all the content available within home network 101. The local search engine 21 manages a local index which can be used to perform custom searches (using the same (or similar) mechanisms as VSE 133) that are relevant to the digital TV context. UPG engine 102 sends each search request to local search engine 21. The local search engine 21 performs the searches within its local index and simultaneously sends the request to VSE 133. Finally, the local search engine 21 merges the results coming from the local index and the VSE 133 and sends them back to UPG engine 102.

Reference is now made to FIG. 2D, which depicts an alternative embodiment of the present invention. In this embodiment, VSE 133 crawls internet 120 (and/or local content) in order to build internet cache 137. VSE 133 crawls a subset of internet 120 and therefore only a subset of internet 120 is indexed and cached. VSE 133 can either cache the original crawled document and produce a snippet with relevant metadata on request; or VSE 133 can cache only the relevant metadata from the crawled document that is to be used when generating the snippet.

Reference is now made to FIG. 2E, which depicts an alternative embodiment of the present invention. In this embodiment, like in the embodiment described above in relation to FIG. 2D, VSE 133 crawls internet 120 (and/or local content) in order to build internet cache 137 but the responses returned by VSE 133 are modified by an Extensible Stylesheet Language Transformation (XSLT) proxy 138. (XSLT is an XML-based language developed by the World Wide Web Consortium (W3C) and used for the transformation of XML documents into other XML or “human-readable” documents.) By using XSLT proxy 138, only a subset of metadata expected by a client device is returned without overloading the response with unwanted metadata that is not suitable for the client device. In this way, a single centralized source of information can be used and customized at the proxy level on a per device basis. In the present embodiment, XSLT proxy 138 is implemented using the HTTP Server of the Apache Software Foundation (httpd.apache.org), together with PHP and XSLT modules.

Reference is now made to FIG. 2F, which depicts an extension to the embodiment described above in relation to FIG. 2E. In this extension, an XSLT proxy cache 139 is provided and in operative association with XSLT proxy 138. For popular search requests whose responses are not accompanied by advertisements, the response can be served directly from the XSLT proxy cache 139. This reduces the amount of VSE traffic.

Referring now to FIG. 10, an example of an architecture of UPG search engine 130 according to embodiments of the present invention will now be described.

VSE 133 crawls remote web sources (e.g. EPG servers 140, internet content servers 150, other users/devices 110) and/or local sources (e.g. devices within home network 101 such as home devices 105). The web source documents and local source documents are parsed and indexed by index builder 132, which produces entries in internet cache 137 and index 190. Search requests are received via front end 191, which passes the search request on to query processor 136. Query processor 136 processes the search request, searches index 190 for relevant documents and instructs snippet generator 131 which information to extract from internet cache 137.

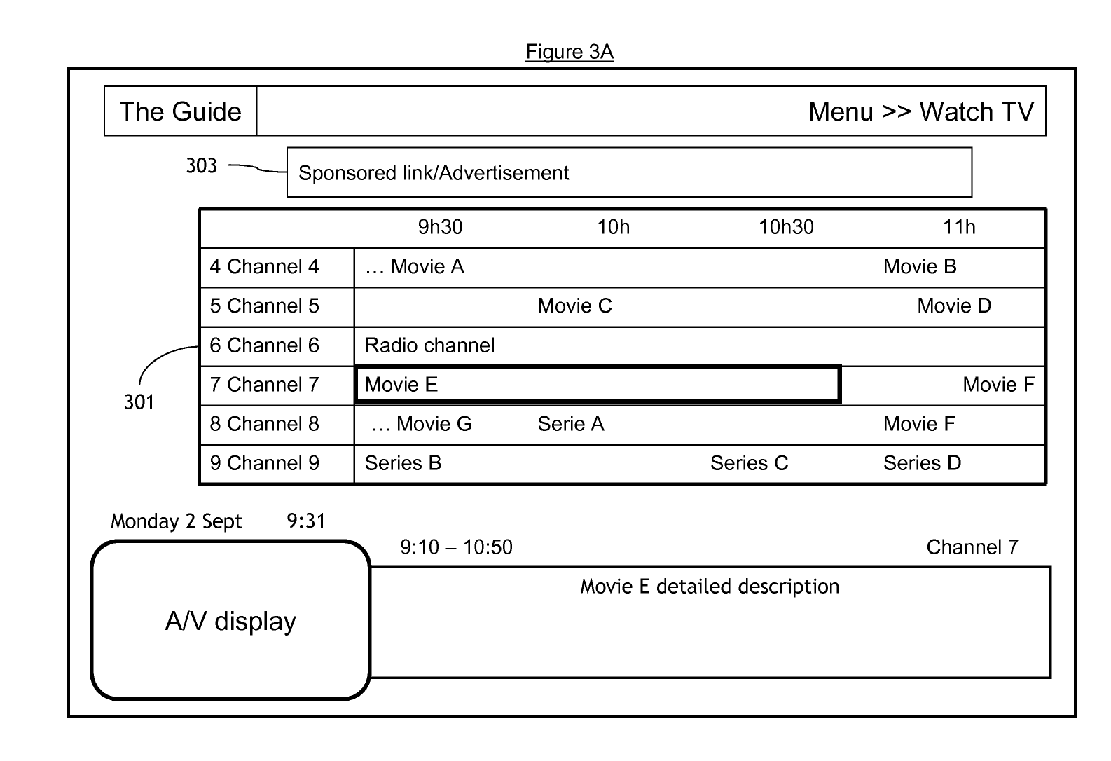

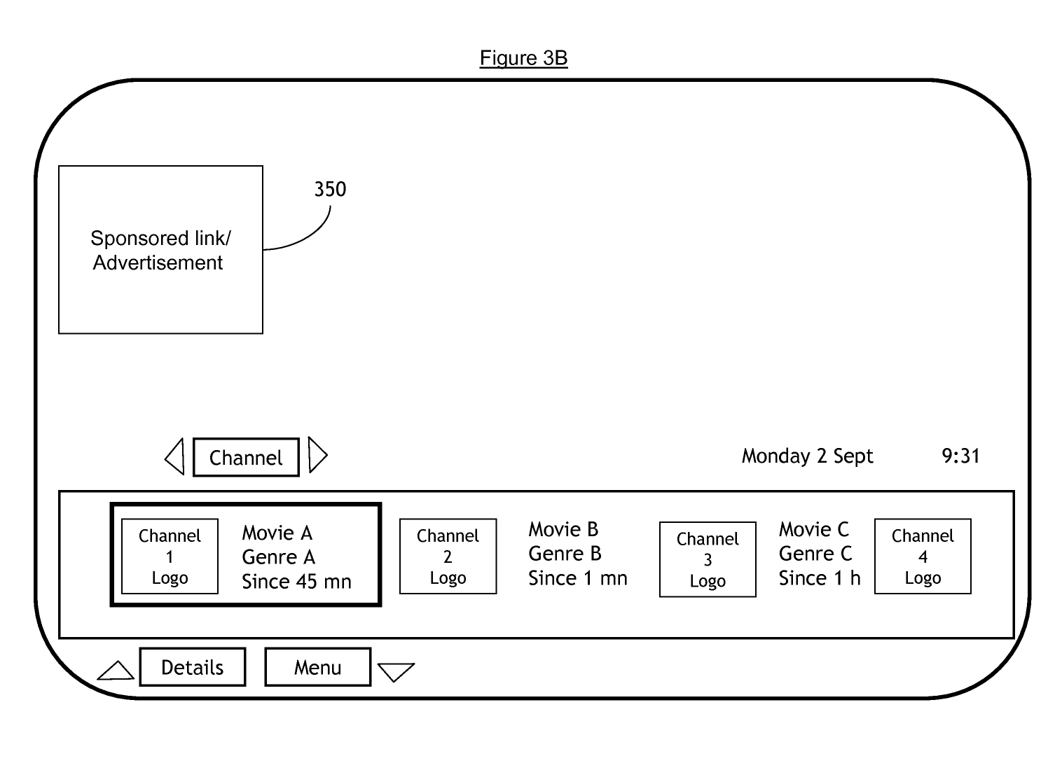

Reference is now made to FIG. 3A, which shows a first example of a UPG screenshot. A grid 301 is displayed on screen: in the present embodiment, six channels (channels 4 to 9) are shown. The programs broadcast on each of the channels during the period 9h30 to 11h are shown in grid 301. Grid 301 is provided with information according to the methods described previously. In the present embodiment, advertisements are displayed in a sponsored link box 301 above grid 301. When a user browses the UPG (e.g. by navigating up or down a page), the advertisements displayed in sponsored links box 303 may change according to the request sent to the Search Engine. The advertisements may be text-only information, text information with a still picture, any combination of the above optionally with a link for launching another portion of the UPG application that can display more information in relation to the advertisement, (e.g. an HTML page).

Reference is now made to FIG. 3B, which shows a second example of a UPG screenshot. In this example, the grid comprises one row with a plurality of columns corresponding to the number of TV channels available in the digital TV bouquet. A horizontal bar is used to browse the list of channels (left/right arrows).

The UPG display is not full screen, rather A/V content previously selected by the end user may still be displayed in the background graphic area. The sponsored link/advertisement in this case is displayed via a widget window 350.

From the UPG application, a search on demand feature is offered to the user, which can search for content according to criteria. This feature can be executed in a seamless way from the perspective of the end user when the end user elects to get more information about a particular event in the UPG (e.g. a trailer, movie poster, picture gallery, UGC, merchandise etc.) From the extended list of information, the user can then search for more content related to the selected event. All requests used for achieving those features are based on the Search Engine capabilities:
Search applied on a particular Content Provider by adding a constraint such as site: www.imdb.com in order to restrict the search to a particular Web Site. Then the Search Engine returns URLs related to the selected events, the snippet generator being in charge to return the subset of metadata extracted from the cached imdb.com pages for the responses.
Search with ranking: when searching for content related to a selected event, the search request is posted to the UPG Search Engine 130. The search results are then ordered by ranking. Such a ranking strategy is managed on the UPG Search Engine 130 side and is defined by the TV Platform operator. For example, ranking could be such that: the first results in the list comprise content distributed by the TV Operator in the digital TV bouquet for free or as part of the subscription(s). Then, VOD content offered by the TV Operator could be at the second ranking level with VOD content offered by third parties (e.g. partners of the digital TV Operator) at a third level, user-generated content (UGC) at a fourth ranking level, etc.

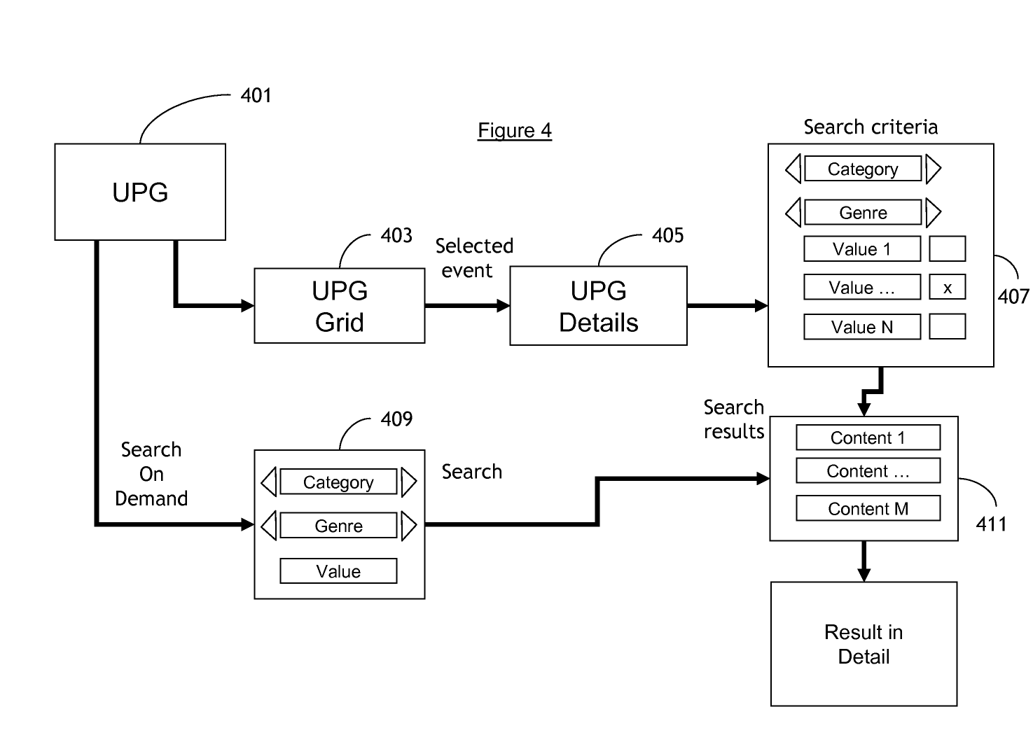

Reference is now made to FIG. 4. From the UPG main application 401, the user can navigate to the UPG grid 403 and then get extended information 405 about a particular event selected from the grid: such extended information is obtained from the UPG Search Engine by posting a request for the selected event and restricting the search by Content Provider (as described in more detail previously). Then, the UPG offers the user the ability to perform a further search to obtain content related to the selected event: this search is based on the “Search with ranking” method described in more detail previously. By reusing metadata associated with the display of the detailed/extended information screen 405, the user is provided with a list of criteria 407 that can be used to set the search criteria that is to be sent to the Search Engine for obtaining the related content search results. This is useful since no user input is required (save for the choice of search criteria to be used, the criteria having been automatically populated by the UPG). One way to provide the list of criteria is similar to the mechanism described in International Patent Application WO 2006/004170 of NDS Limited based. However, in the present embodiment, a subset of the proposed criteria is used and said criteria are not retrieved from EIT but from the detailed metadata as returned by the Search Engine.

From the UPG main application 401, the user can also perform a search on demand 409, which offers the user the ability to:
Select the Category for the search (e.g. from: ALL, digital TV bouquet, VOD, user-generated content, local content, etc.);
Select a genre for the search (e.g. from: ALL, audio, video, merchandise etc.);
Enter a textual description of the search criteria in an input textbox (e.g. the end device is provided with a keyboard or a Remote Control where Alpha numeric key can be used to input text similar to text input on a mobile phone. Speech recognition is also a possible mechanism for inputting the textual description).
   The “search with ranking” method described previously is then used to return search results 411 to the end user.

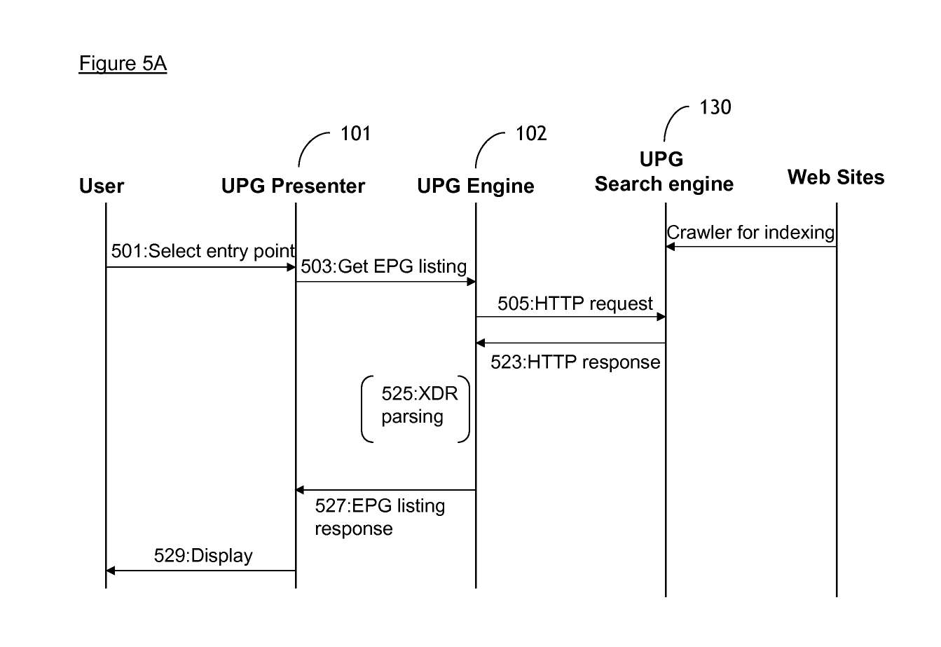

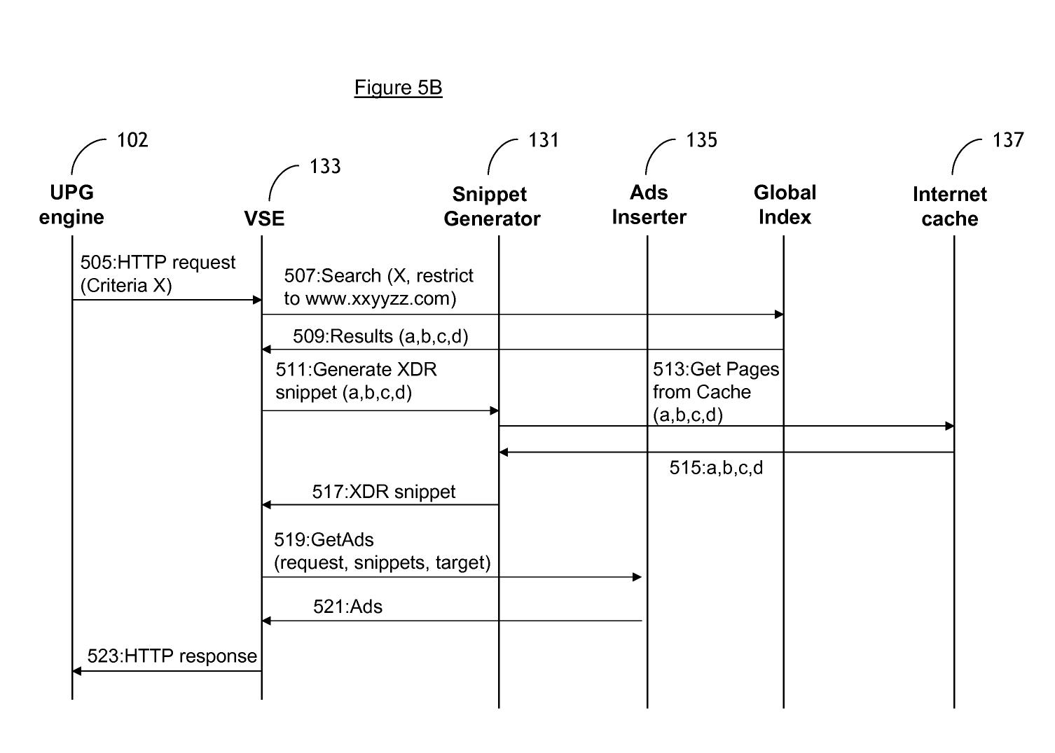

Reference is now made to FIGS. 5A and 5B, which are information flow diagrams showing the information flows during a UPG search request.

The end user enters the UPG by choosing one of the possible entry points (e.g. a TV (broadcast) event, a VOD asset, an item of UGC, a UPG grid search request etc.) (step 501). The UPG presenter sends a request for event metadata to the UPG engine (step 503). The UPG Engine transforms this request into an HTTP request and transmits the HTTP request to the UPG Search Engine (step 505). The UPG search engine (which comprises the Vertical Search Engine, the snippet generator, and optionally the Ads inserter) performs the request within the global index using additional parameters to specify the VSE context (e.g. site restriction) and returns the results as an HTTP response to the UPG engine (step 523). The result is received by the UPG engine, parsed (step 525). Then the UPG listing is generated and transmitted to the UPG Presenter (step 527) and displayed to the end user (step 529).

Reference is now specifically made to FIG. 5B, which shows a flowchart of exchanges within the UPG Search Engine for search request management and XDR snippet generation. It will be recalled that the Vertical Search engine (VSE) receives the HTTP search request from the UPG engine (step 505). The VSE then performs the search within the global index (step 507). The VSE is typically customized in order to return only relevant results for the TV context. For example, in the present embodiment VSE customization restricts the scope of the search within the global index to a predefined Web site (www.xxyyzz.com). The global index sends back to the VSE the URLs of content (i.e. locators that are understandable by the end user device) which match the search criteria (criteria X) and the VSE customization (step 509). The VSE then requests that the snippet generator produce an XDR compliant content description for each item of content listed in the search results (step 511). In order to build this summary, the snippet generator retrieves the document (e.g. web page) from the Internet cache, analyses it, and identifies the relevant information based on rules provided by the VSE (steps 513/515). The XDR compliant snippets are then returned to the VSE (step 517). Then, the VSE requests the Ads Inserter to return advertisements by providing criteria based on the snippets, initial UPG request and the target (e.g. the device running the UPG or the end user's profile) (steps 519/521). Finally, the VSE returns the HTTP response to the UPG engine with content URLs and snippets compliant with the XDR format (step 523).

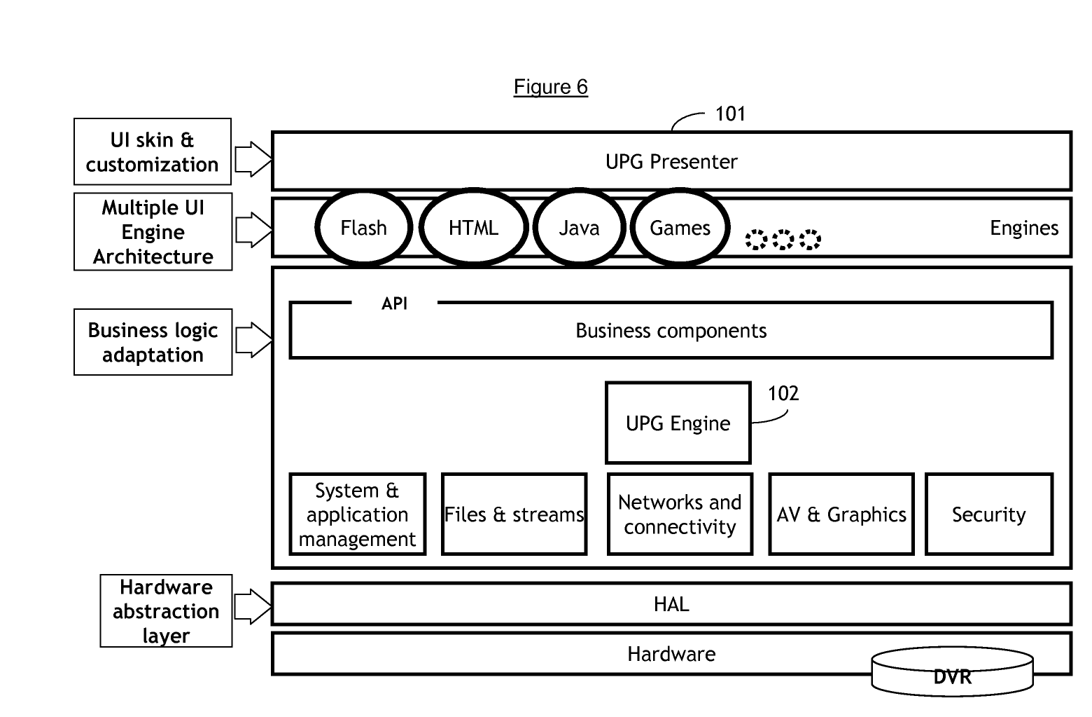

Reference is now made to FIG. 6, which shows an end user device architecture (e.g. a STB) according to embodiments of the present information. The UPG Presenter is the end user application that runs over an interactivity engine such as a browser, a Flash engine, a Java engine or a Game engine. A user API is provided as the middleware entry points in order to use the Business Logic components implemented in the middleware. The middleware is typically agnostic of the interactivity engine running on top of it. In the present invention, the middleware also comprises the UPG Engine that exchanges search requests/responses with the Search Engine.

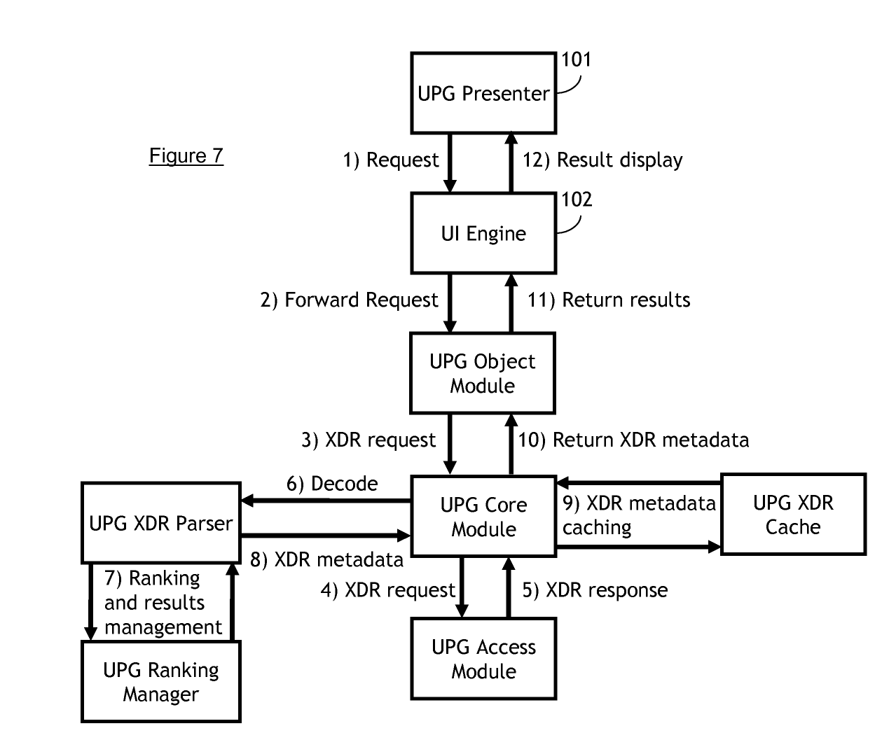

Reference is now made to FIG. 7, which shows the UPG system architecture according to embodiments of the present invention.

### Step 1: Request

When an end user interacts with the UPG presenter (in order to obtain detailed information about TV events for a particular channel (e.g. Channel 1)), the UPG presenter then sends a request to the UI engine.

### Step 2: Forward Request

The UI engine forwards the request to a UPG object module. In the present embodiment, the request requests the next four TV events to be broadcast on Channel 1 (e.g. GET_EVENTS(BBC1,4)).

### Step 3: XDR Request

The UPG object module then builds the query terms of the XDR request from the received request. In the present embodiment certain criteria are automatically added to the query (e.g. the date and the preferred language for the metadata, which is useful for filtering the search results in the appropriate language when content is available in multiple languages.) The XDR request (e.g. (channelname:BBC1 and startdate>=“2006/12/31 15:00:00”)&lang=EN) is then forwarded to the UPG Core module with an indication that four results are expected.

### Step 4: XDR Request

The UPG Core Module posts the XDR request (e.g. an HTTP request) to UPG access module with optional HTTP header elements (e.g. cookies). In the present embodiment, a further criteria is added to the query: the maximum number of results expected. Although the request received from the upper layer was for four TV events, the maximum number of results is set to a higher value. An example of a typical search request posted to the UPG access module is:

http://www.ndsyse. com/tv?_q=(channelname:BBC1&startdate>=“2006/12/3115 :00:0 0”)&lang=EN&results=20.

### Step 5: XDR Response

An XDR response (e.g. an HTTP response) is received and the XML body is forwarded to the UPG core module.

### Step 6: XDR Decode

The XML document is forwarded to the UPG XDR parser for decoding. The XDR parser analyzes the number of TV events returned, the advertisements associated with the search and suggestions for related assets (e.g. VOD, UGC, etc.)

### Step 7: Ranking and Results Management

The UPG Ranking Manager applies a ranking strategy to the results, i.e. from the responses, it extracts the suggested advertisements and suggested associated content.

### Step 8: XDR Metadata

The UPG Core Module receives from the UPG XDR parser the list of

TV events matching the request together with the associated content (e.g. advertisements, VOD, UGC, etc.)

### Step 9: XDR Metadata Caching

The results are cached in UPG XDR cache.

### Step 10: Return XDR Metadata

Metadata associated with the first four TV events is returned to the UPG object module.

### Step 11: Return Results

The search results are returned to the UPG engine.

### Step 12: Results Display

The search results are returned to the UPG presenter and displayed to the user, optionally with the advertisements and related content suggestions.

An example of a query language used by VSE 133 in embodiments of the present invention will now be described. When receiving a search request, the VSE 133 query parses the search request into an XML object representing a query tree. Then, the query tree is expanded by query expansion modules to enrich it (synonym, semantic) or to interpret it. A new query tree is thereby generated. Custom query processing modules can then modify the query tree before it is sent to the index server to be executed.

Then, each tree leaf is associated with a collection of documents for which the corresponding predicate is true, thus producing a list of documents which are combined according to the operators (e.g. AND, OR, etc.) found in the inner nodes of the query tree. Document lists are then combined up to the root node of the tree in order to obtain a results set for the query. At the same time, documents lists are combined and a score value is computed for each predicate. The score values are then merged together to compute the overall document score. The final ranking score is added to two other score values that are assigned globally to each matching document:
A proximity bonus (depending on the relative position of the search query terms in the document); and
A static score assigned to the document when it has been indexed (e.g. a bonus value is given to documents in the index known to be popular).

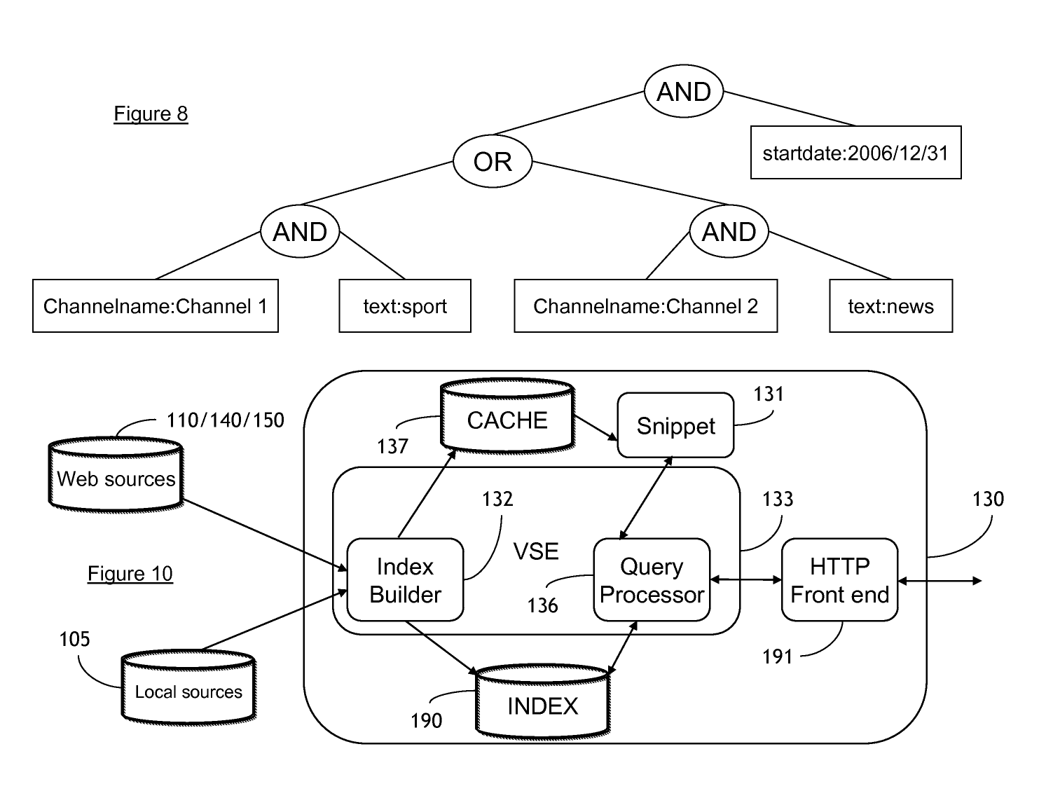

Referring now to FIG. 8, a user has submitted a search for TV programs broadcast on Channel 1 containing the word ‘sport’ or TV programs broadcast on BBC2 containing the word ‘news’, and broadcast on 31 Dec. 2006. The corresponding query “(((channelname:BBC1 sport) OR (channelname:BBC2 news)) AND date:2006/12/31)” is expanded in a query tree as shown in FIG. 8.

A basic score computation example is a combination of the score class of the search term predicate (as defined in the original document when it was indexed) and the weight of the predicate in the query (e.g. the frequency of the query term).

The query operators used in the query (e.g. OR, AND etc.) may also affect the score (addition, multiplication, minimum, maximum etc.).

Indexing documents may also affect the score computation: when a search predicate matches an index field, the score value may be increase by a formula associated with this search field (in this way, search results with a genre defined as ‘sport’ can be presented before search results with ‘sport’ in the description).

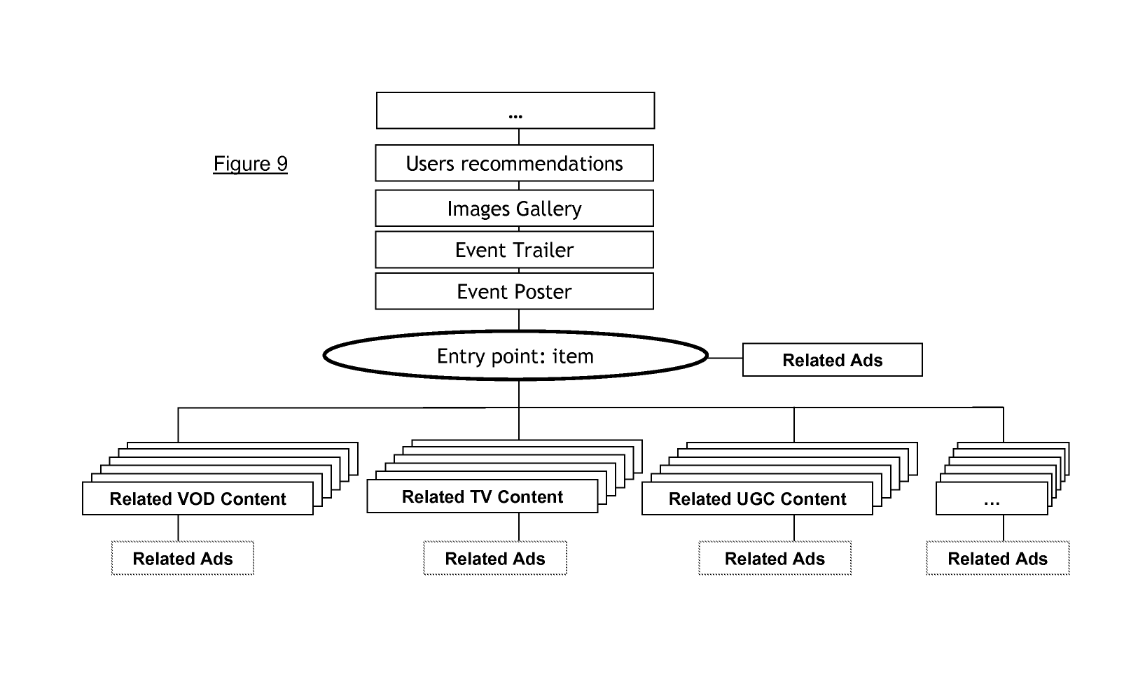

Reference is now made to FIG. 9, which shows a representation of content access in the UPG system. All content types and categories can be accessed in a seamless way including via a classical grid based model as described above in relation to FIGS. 3A and 3B. Access to the UPG is based on an entry point. An entry point item can be, but is not limited to: a TV event (i.e. TV broadcast event), a VOD asset, an item of UGC, a UPG grid search request etc. For an entry point, the UPG system can obtain material related to the entry point, e.g. poster URL, trailer URL, images gallery (list of still picture URLs) etc.; and related advertisements. The UPG system can also access associated/related content, classified by the ranking methods described above. Each item of associated content may also be provided with its own set of related content as well as with related advertisements.

In alternative embodiments, the overall architecture described above is used to build an archive UPG, i.e. a UPG used to browse past events that are no longer available in the digital TV Bouquet. As explained, by way of non-limiting example, in International Patent Application published as WO 2008/012488, by using a P2P system between end user devices such as a STB, it is possible for a user missing a broadcast event to recover it from another user's device via the P2P network. The present invention could be used to get old information related to the digital TV Bouquet by using Web archive metadata stored by the Search Engine.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof.

1. A method for retrieving metadata for use in a content guide, said method comprising:
crawling one or more crawlable data sources;
storing metadata extracted from said one or more crawlable data sources in an indexed cache;
receiving a search request from a client according to search criteria, said search request requesting metadata for use in said content guide;
searching a subset of said indexed cache according to said search criteria;
extracting metadata from said indexed cache as results of said searching;
generating relevant metadata from said results, said relevant metadata comprising metadata suitable for use by said client in said content guide; and
transmitting said relevant metadata to said client for use in said
content guide.

2. The method of claim 1, wherein said one or more crawlable data sources comprise one or more web pages.

3. The method of claim 2, further comprising storing said one or more web pages in said indexed cache; and extracting one or more web pages from said indexed cache as results of said searching.

4. The method of claim 1, wherein said one or more crawlable data sources further comprises one or more local data sources within a network to which said client has access.

5. The method of claim 1, further comprising identifying advertisements for display in said content guide in dependence on said relevant metadata; and transmitting said advertisements to said
client with said relevant metadata.

6. The method of claim 5, wherein said identifying advertisements is further dependent on one or more of said search criteria, said client, a history of search requests received, and advertisements previously identified and transmitted to said client.

7. The method of claim 1, wherein said search criteria specifies said subset of said indexed cache.

8. The method of claim 1, wherein said search criteria is established from said relevant metadata.

9. The method of claim 1, further comprising receiving a further search request according to further search criteria, said further search request requesting content related to content selected using said content guide.

10. The method of claim 9, wherein said further search criteria is established from said relevant metadata.

11. The method of claim 9, wherein said further search criteria is specified by a user of said content guide.

12. A method for retrieving metadata for use in a content guide installed on a client device, said method comprising:
sending a search request according to search criteria to a search server, said search request requesting data for use in said content guide, wherein said search server is operable to crawl one or more crawlable data sources, store metadata extracted from said one or more crawlable data sources in an indexed cache, search a subset of said indexed cache according to said search criteria, extract metadata from said indexed cache as results of said searching, generate relevant metadata from said results, said relevant metadata comprising metadata suitable for use in said content guide, and transmit said relevant metadata to said client device;
receiving said relevant metadata from said search server; and
presenting said relevant metadata in a content guide.

13. The method of claim 12, wherein said one or more crawlable data sources comprise one or more web pages.

14. The method of claim 13, wherein said search server is operable to store said one or more web pages in said indexed cache; and extract one or more web pages from said indexed cache as results of said searching.

15. The method of claim 12, further comprising publishing content available within a network to which said client has access, wherein said search server is further operable to crawl said content and store said content in said indexed cache, wherein said content can be included in the search by said search server in response to said search request.

16. The method of claim 15, further comprising publishing said content directly to said search server.

17. The method of claim 15, further comprising publishing said content to a web page crawled by said search server.

18. The method of claim 12, further comprising:
crawling content available within a network to which said client has access;
storing said content in a local indexed cache;
searching a subset of said local indexed cache according to said search criteria;
extracting content from said local indexed cache as local results of said searching;
generating relevant local metadata from said local results;
merging said relevant local metadata with said relevant metadata; and
presenting said local relevant metadata and said relevant metadata in a content guide.

19. The method of claim 18, wherein said indexed cache comprises said local indexed cache.

20. Apparatus for retrieving metadata for use in a content guide, said apparatus comprising:
crawling means for crawling one or more crawlable data sources;
indexed storage means for storing metadata extracted from said one or more crawlable data sources;
searching means for receiving a search request from a client according to search criteria, said search request requesting metadata for use in said content guide, and for searching a subset of said indexed storage means according to said search criteria; and
extraction means for extracting metadata from said indexed storage means as results of said searching, and for generating relevant metadata from said results, said relevant metadata comprising metadata suitable for use by said client in said content guide;
wherein said searching means is operable to transmit said relevant metadata to said client for use in said content guide.

21. A search engine for retrieving metadata for use in a content guide, said search engine comprising:
a global search engine operable to crawl one or more crawlable data sources;
an indexed cache operable to store metadata extracted from said one or more crawlable data sources;
a vertical search engine operable to receive a search request from a client according to search criteria, said search request requesting metadata for use in said content guide, and further operable to search a subset of said indexed cache according to said search criteria; and
a snippet generator operable to extract metadata from said indexed cache as results of said searching, and further operable to generate relevant metadata from said results, said relevant metadata comprising metadata suitable for use by said client in said content guide;
wherein said searching means is further operable to transmit said relevant metadata to said client for use in said content guide.

22. A client device comprising:
presentation means for presenting a content guide to a user;
searching means for receiving a search request according to search criteria from said presentation means, and sending said search request to a search server, said search request requesting data for use in said content guide, wherein said search server is operable to crawl one or more crawlable data sources, store metadata extracted from said one or more crawlable data sources in an indexed cache, search a subset of said indexed cache according to said search criteria, extract metadata from said indexed cache as results of said searching, generate relevant metadata from said results, said relevant metadata comprising metadata suitable for use in said content guide, and transmit said relevant metadata to said client device; and
receiving means for receiving said relevant metadata from said search server, and wherein said presentation means is operable to present said relevant metadata in said content guide.

23. A client device comprising:
a guide presenter operable to present a content guide to a user; and
a guide engine operable to receive a search request according to search criteria from said guide presenter, and send said search request to a search server, said search request requesting data for use in said content guide, wherein said search server is operable to crawl one or more crawlable data sources, store metadata extracted from said one or more crawlable data sources in an indexed cache, search a subset of said indexed cache according to said search criteria, extract metadata from said indexed cache as results of said searching, generate relevant metadata from said results, said relevant metadata comprising metadata suitable for use in said content guide, and transmit said relevant metadata to said client device;
wherein said guide engine is further operable to receive said relevant metadata from said search server, and send said relevant metadata to said guide presenter, and wherein said guide presenter is further operable to present said relevant metadata in said content guide.
